(19) United States
(12) Patent Application Publication
(10) Pub. No.: US 2014/0207631 A1
(43) Pub. Date: Jul. 24, 2014

(54) Systems and Method for Analyzing and Validating Invoices

(71) Applicant: Jason M. Fisher, Collierville, TN (US)

(72) Inventor: Jason M. Fisher, Collierville, TN (US)

(21) Appl. No.: 13/747,846

(22) Filed: Jan. 23, 2013

(51) Int. Cl. G06Q 40/00; G06K 9/82

(52) U.S. Cl. CPC G06Q 40/10; G06K 9/82
USPC 705/30; 382/229

(57) ABSTRACT

A system and method for management and processing a plurality of types of invoices at a user's site involving importing the plurality of types of invoices to provide comparable invoices and auditing the comparable invoices by performing an automated reasonability test on the comparable invoices. The system and method also provide a means for approving, processing and reporting on the comparable invoices.

### BACKGROUND OF THE INVENTION

1. Field of the Invention

The present invention relates to a system and method for electronically processing and validating a plurality of types of invoices.

2. Background Art

The traditional methods of collecting, reviewing and validating vendors' invoices, especially periodic invoices, e.g., telecommunications and utility bills, are a manual process. These methods impose substantial difficulties for users having large volumes of such invoices. This is especially true when there are multiple vendor invoices.

Despite the fact that, for example, telecom invoices are often received via Electronic Data Interchange (EDI), many vendors still provide only paper invoices. While paper invoices enable a vendor to provide billing information to any customer regardless of their technology infrastructure, this flexibility impedes customers from analyzing and auditing the billing information. While paper invoices may be scanned and converted into machine encoded text via optical character recognition, the billing components in the machine encoded text and the relationships between them are not in a form that can be analyzed.

Identification of the billing components is particularly difficult because invoices differ from vendor to vendor, and from billing platform to billing platform. Vendors may use different terminology to denote the same billing components. Moreover, billing components may be arranged in different locations from invoice to invoice. Finally, even if the billing components are in the same locations and referenced using the same terminology, the relationships between the billing components may defined differently from invoice to invoice. For example, one invoice may include certain taxes as part of the total line charges but another invoice may not include the taxes.

As a result of the structural differences between various invoices, users are typically forced to manually enter and audit the billing information for each invoice. Because of the large amount of billing information contained in an invoice, and the complicated billing component relationships, users spend a substantial amount of time entering and auditing invoices.

The problem is exacerbated when there are multiple invoices representing multiple vendors and multiple billing platforms. For example, a customer may receive an invoice from Verizon, an invoice from Sprint, and wireless and MPLS invoices from AT&T. Each invoice may have different billing components, and the billing components may be arranged in different locations. Because the invoices are structured differently, users would have to spend significant time entering and auditing the invoices. In addition to being cumbersome, the process would be highly error prone.

What is therefore needed is a system for automatically capturing and auditing billing information from invoices.

### SUMMARY OF THE INVENTION

The current invention provides a system and a method that permits a user to electronically process and validate a plurality of types of invoices, particularly telecommunication and utility invoices. A type of invoice includes, but is not limited to, paper based invoices from a plurality of vendors and billing platforms. A plurality means at least two different types of invoices can be received. The system includes a means for processing a plurality of types of invoices and a means for performing a validation test on the invoices at the user site. More specifically, this invention provides a system for processing a plurality of types of invoices received by a user from a plurality of vendors.

Using the present invention, a user can (1) receive invoice information contained in a paper invoice from a vendor; (2) automatically process the invoice information, resulting in either approval of the invoice information or identification of billing exceptions. The advantages of the present invention over conventional systems and techniques are numerous and include the following: (1) automatic paper invoice processing thus increasing efficiency; (2) a drastic reduction in the administrative costs and human resources needed for processing invoices; (3) a real time updating of vendor specific invoice rules and templates and thus no out of date rules or templates for the user; (4) an electronic data input to accounting systems, reducing invoice inaccuracies; (5) facilitating the generation of a large number of specialized reports, including audit, summary and customizable (custom) reports, that will provide the user with valuable feedback on the transactions that are processed through the system; and (6) an improved way to communicate and provide feedback to the user regarding the invoices received from the vendors.

### BRIEF DESCRIPTION OF THE DRAWINGS

FIG. 1 is a data flow diagram which depicts the flow of data between major processes in the present system.

FIG. 2 illustrates a block diagram of the Optical Invoice Recognizer (OIR) engine.

FIG. 3 illustrates an example paper invoice.

FIG. 4 illustrates the second page of the paper invoice in FIG. 3.

FIG. 5 illustrates a XML file generated by the Optical Invoice Recognizer (OIR) engine based on the example paper invoice of FIG. 3.

FIG. 6 is a flowchart of an illustrative method for verifying an invoice for completeness and accuracy according to an embodiment of the present invention.

FIG. 7 illustrates a block diagram of an exemplary computer system on which the embodiments can be implemented

### DESCRIPTION OF THE INVENTION

An embodiment of the present invention provides an Optical Character Recognition (OCR) engine, an Optical Invoice Recognition (OIR) engine that includes a preprocessor and an analysis engine, and software thereof. In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

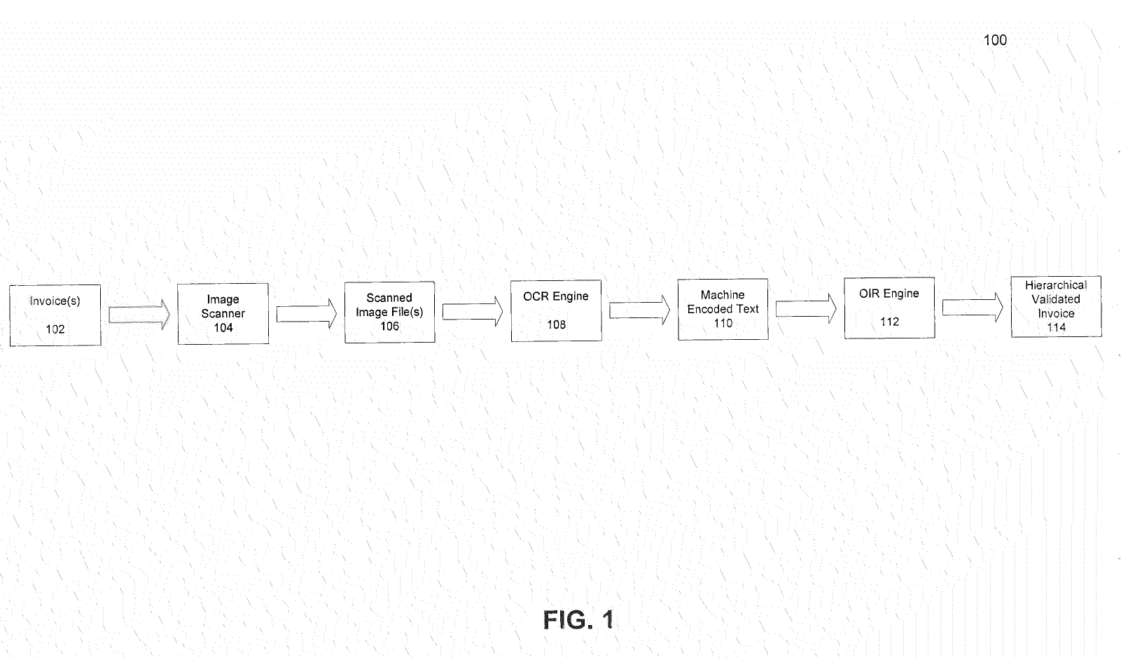

FIG. 1 is a data flow diagram which depicts the flow of data between major processes in the present system. The system is made up of various modules that can receive inputs of vendor invoices and provide output to a user, a user database, a user human resource system, and a user accounting system. A module is a component of the system that has a predefined set of inputs and outputs. These inputs and outputs can be from or to the system or user.

The system includes means for: importing various types of paper invoices to an Optical Character Recognition (OCR) engine 108 to provide equivalent machine encoded text versions of the invoices. The system also includes means for: importing machine encoded text representing a invoice to an Optical Invoice Recognition (OIR) engine 112 to validate the billing information contained in the invoice. OIR engine 112 includes means for: locating and capturing billing components contained in the invoice, including, but not limited to, billing identifiers such as phone numbers, circuit IDs, and meter IDs; charges such as service charges, usage Charges, usage amounts, taxes, and surcharges; and amounts such as quantities, minutes, messages, and kW. OIR engine 112 also includes means for: validating, approving and processing the invoice information. The following sections describe the various means to accomplish these functions.

Diagram 100 includes invoices 102, image scanner 104, scanned image file(s) 106, OCR engine 108, machine encoded text 110, OIR engine 112, and validation result 114.

Invoices 102 include one or more paper invoices from one or more vendors. The invoices each include one or more billing components. In the case of telecom invoices, the billing components may represent phone numbers, circuit IDs, service charges, usage charges, usage amounts, taxes, and surcharges associated with a client's services.

Billing components are associated with other billing components. Typically billing components are arranged hierarchically with respect to other billing components. For example, most telecommunication invoices have a summary level of charges that includes billing components like the previous month's billing, the amount paid, late charges, and the current month's charges. The next level of detail under the current month's charges may include a summary of the charges by each billing identifier. For example, there may be a summary of charges for each phone number, circuit ID, device ID, or location ID. Below the summary charges for each billing identifier is typically another level of detail. For example, in the case of a phone number there may be the total service charges, the total usage charges, and the total taxes. Finally, below each of these charges is typically another level of detail. For example, in the case of total taxes, there are federal, state, and county taxes. At the most granular level of detail there will be usage details such as the actual call itself, including such details as the time of day, duration, called number, cost, etc.

As would be appreciated by a person of ordinary skill in the art, invoices are often different structurally from vendor to vendor and from billing platform to billing platform. Specifically, invoices may vary based on the number of billing components, type of billing components, and the relationships between billing components, in case of vendors, invoices from AT&T may have a different number of billing components compared to invoices from Verizon. In the case of billing platforms, billing components in wireless invoices from AT&T may be located in different positions than billing components in MPLS invoices from AT&T.

Invoices 102 are processed by image scanner 104 to produce scanned image files 106. Image scanner 104 is a device that optically scans images, printed text, handwriting, or an object, and converts it to a digital image. Scanned image files 106 are digital image representations of invoices 102. In an exemplary embodiment, scanned image files 106 are Tagged Image File Format (TIFF) files. The Tagged Image File Format is a file format for storing images that is popular among graphic artists and the publishing industry. However, as would be appreciated by a person of ordinary skill in the art, various other types of image file formats such as Joint Photographic Experts Group (JPEG) file format and the Portable Network Graphics (PNG) file format may be used to represent scanned image files 106.

Scanned image files 106 are processed by Optical Character Recognition (OCR) engine 108. OCR engine 108 receives the scanned image files 106 and produces machine encoded text 110. As would be appreciated by a person of skill in the art, OCR is the mechanical or electronic conversion of scanned images of handwritten, typewritten or printed text into machine encoded text. It is widely used as a form of data entry from some sort of original paper data source, whether documents, sales receipts, mail, or any number of printed records.

In an exemplary embodiment, OCR engine 108 produces one or more PDF files of the invoices. The PDF files contain the machine encoded text 110 generated by OCR engine 108. While the PDF file format may be used to represent machine encoded text 110, as would be appreciated by a person of skill in the art, various other file formats may be used to represent machine encoded text 110. For example, plain text files, rich text files, etc. may be used to represent machine encoded text 110.

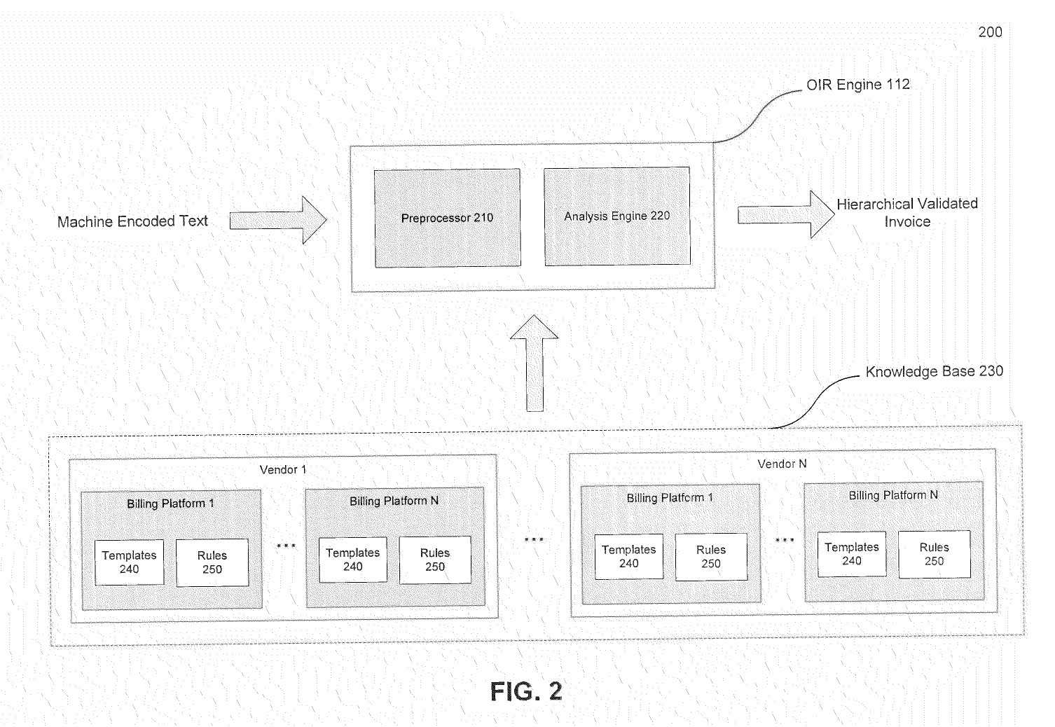

Machine encoded text 110 is processed by Optical Invoice Recognition (OIR) engine 112. Alternatively, machine encoded text 110 that does not come from the scanning and OCR process may be inputted and processed by OIR engine 112. OIR engine 112 interprets the machine encoded text to create a hierarchy of billing information that is analyzed and validated to produce a hierarchical validated invoice 114. Hierarchical validated invoice 114 indicates that the provided invoice is complete and accurate. OIR engine 112 is described in further detail in FIG. 2 below.

FIG. 2 illustrates a block diagram of the Optical Invoice Recognizer (OIR) engine 112. OIR engine 112 is used to analyze and validate the machine encoded text of the paper invoices. In particular, OIR engine 112 ensures that an invoice contains complete and accurate billing components. OIR engine 112 receives machine encoded text and outputs a hierarchical validated invoice.

OIR engine 112 is made up of various modules and receives as input machine encoded text and outputs to a user or system a hierarchical validated invoice. A module is a component of the system that has a predefined set of inputs and outputs. These inputs and outputs can be from or to the system or user. The system includes means for: importing types of invoice information produced by OCR engine 108 and associating the information into a hierarchy and validating it.

OIR engine 112 includes a preprocessor 210 and an analysis engine 220. In addition, OIR engine 112 utilizes knowledge base 230. Knowledge base 230 includes information associated with a plurality of vendors and billing platforms. More specifically, each billing platform includes templates 240 and rules 250, wherein each billing platform is associated with one of the plurality of vendors.

In an exemplary embodiment, preprocessor 210 receives machine encoded text 110 generated by OCR engine 108. Preprocessor 210 identifies the vendor and billing platform associated with the machine encoded text of the invoice. In addition, preprocessor 210 locates and captures all of the billing components specific to that vendor and billing platform in the machine encoded text. Preprocessor 210 not only captures all of the billing components but also retains the associations between the billing components.

In order to identify the billing components and the associations between them, preprocessor 210 must first identify the vendor and billing platform associated with the invoice. In particular, the machine encoded text of the invoice is compared with a general knowledgebase that looks for any number or combinations of words and phrases, the spatial relationships of these words, and images. As would be appreciated by a person of ordinary skill in the art, various pattern matching methods may be applied to the machine encoded text in order to determine the vendor and billing platform associated with the invoice.

Once the vendor and billing platform have been identified, preprocessor 210 identifies and locates the billing components contained in the invoice. Preprocessor 210 uses the identified vendor and billing platform information to locate a vendor and billing platform specific template 240 from knowledgebase 230. Template 240 represents a generalized representation of an invoice that is specific to the identified vendor and billing platform. As would be appreciated by a person of ordinary skill in the art, various structures and formats may be used to model template 240. For example, structured document formats such as XML may be used to model such templates.

Preprocessor 210 applies template 240 to the machine encoded text in order to identify the billing components. As would be appreciated by a person of ordinary skill in the art, various methods and techniques may be used to apply the template to the machine encoded text in order to identify the billing components and the relationships between said billing components. For example, various pattern matching rules contained in the template may be used to determine which template elements correspond to which billing components in the machine encoded text representing the invoice. The patterns may range from tag names to very complicated patterns that match very specific billing components of the machine encoded text representing the invoice.

Once template 240 has been applied to the machine encoded text, preprocessor 210 outputs a hierarchical data structure that contains all the billing components and a unique tag number for each billing component. Because the billing components are arranged in a hierarchical data structure, the relationships between the billing components are captured implicitly in the hierarchical data structure. In an exemplary embodiment, the hierarchical data structure is represented as an XML (Extensible Markup Language) file. However, as would be appreciated by a person of ordinary skill in the art, various structures and file formats may be used for the hierarchical data structure.

Analysis engine 220 receives the hierarchical data structure and outputs a hierarchical validated invoice. In other words, in the exemplary embodiment, analysis engine 220 analyzes the XML invoice and validates it by checking the included billing components for completeness and accuracy.

In order to check for completeness and accuracy, certain billing components should always be present for certain vendor invoices and for certain billing platforms. In particular, in the majority of telecommunication invoices the following components are captured at the highest level: invoice date, due date, account number, remittance information, total amount due, currently monthly charges, etc. At the next level, there may be a check of whether the sum of the child billing components are equal to their parent billing components. Every branch of the billing components is validated to make sure the calculation involving the child billing components equals the parent billing components.

In order for analysis engine 220 to analyze and validate invoices the analysis engine applies a set of rules 250 from the corresponding knowledge base 230. Rules 250 are a collection of vendor and billing platform specific rules. A rule consists of a pattern that describes how the rule can be applied to the hierarchical data structure and an action that describes what should be done when the rule is applied. Optionally, a rule can have further conditions that restrict the applicability of the rule. For example, the rule may only be applied if another rule has previously been applied. In an exemplary embodiment, rules 250 define an implicit strategy to exhaustively apply all the rules.

As would be appreciated by a person of ordinary skill in the art, various structures and formats may be used to represent rules 250. In addition, as would be appreciated by a person of ordinary skill in the art, various methods and techniques may be used to apply the rules to the machine encoded text in order to analyze and validate the billing components and the relationships between the billing components.

If there are any billing components that are not calculated properly after rules 250 have been applied, then analysis engine 220 knows there is an issue with OCR engine 108 or the rules 250 in knowledge base 230 are incomplete. In the case of a problem with OCR engine 108, there is either a OCR problem with the parent billing component or one of its child components. In the case of an incomplete knowledge base 230, there is either a missing rule(s) or the rule(s) have been incorrectly defined for the given vendor and billing platform. In either case, the unique tag numbers associated with each billing component in the hierarchical data structure are flagged as needing to be corrected. This ensures that it is easy and quick for a person to correct either a OCR problem or further train the knowledge base 230. Further training the knowledgebase may include adding additional rules or correcting existing rules in rules 250 for the identified vendor and billing platform.

If the billing components are complete and accurate, then the invoice is likely correct. Analysis engine 220 generates a successful validation result and the sends the hierarchical validated invoice to be imported and analyzed by other modules.

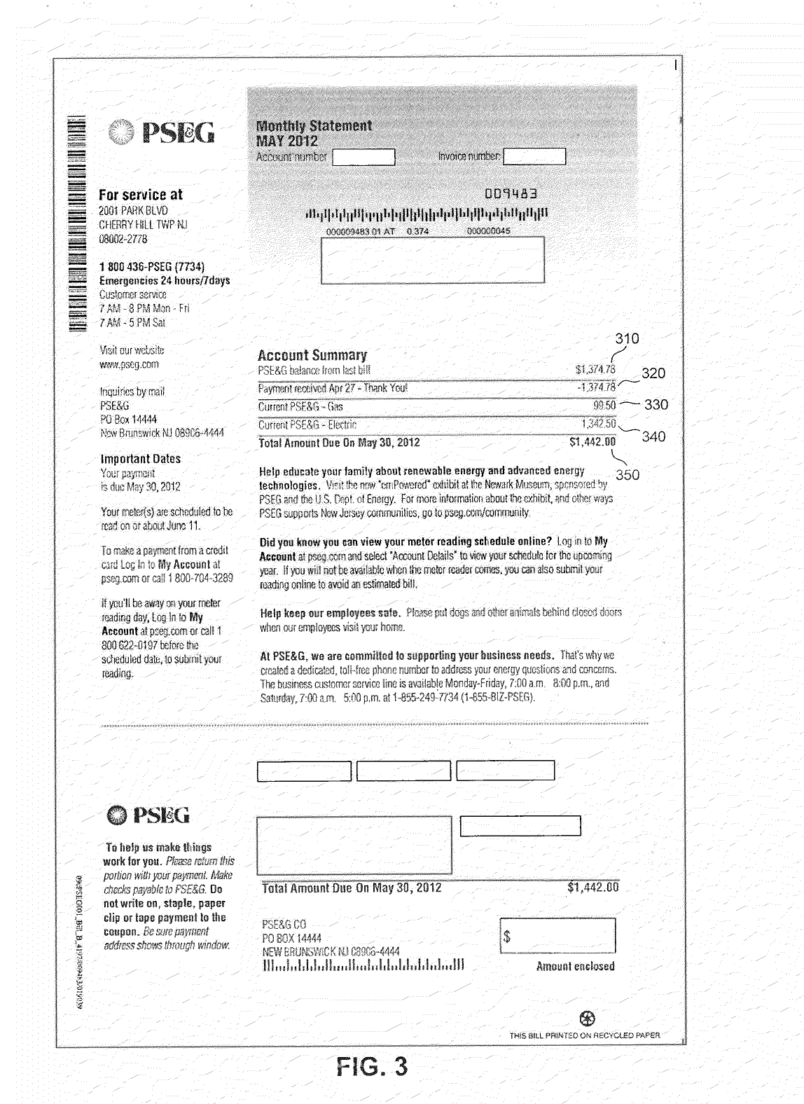

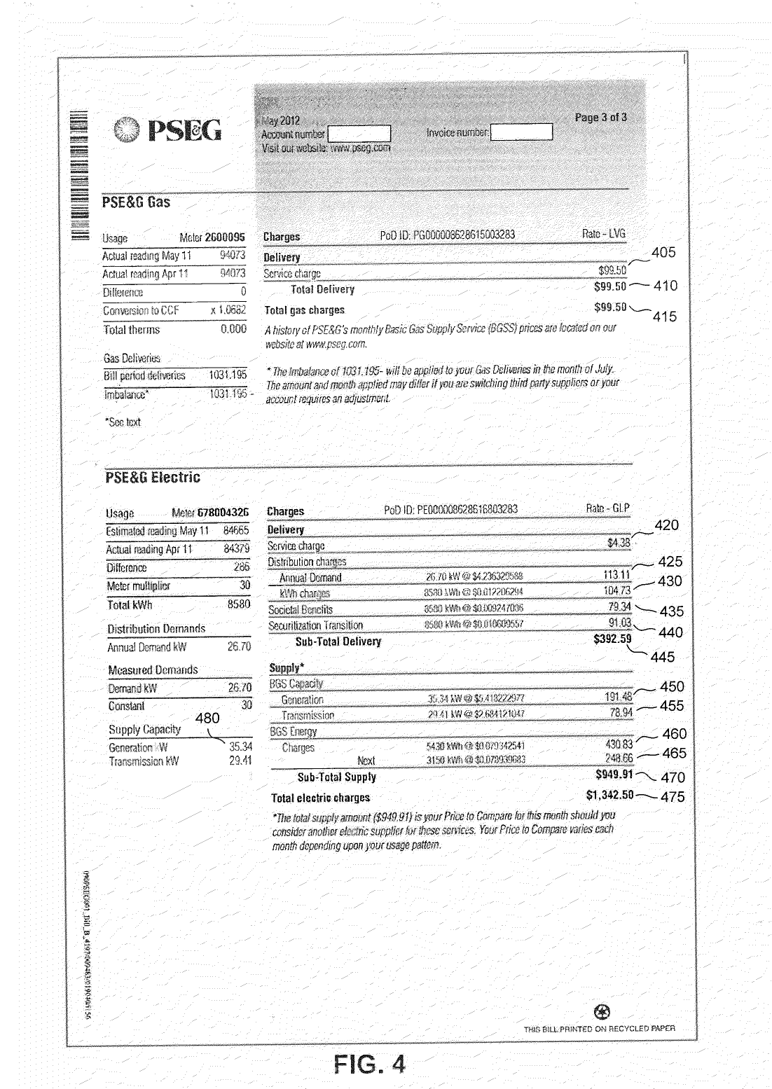

An example paper invoice is illustrated in FIGS. 3 and 4. The paper invoice is a monthly gas and electric bill. FIG. 3 illustrates the first page of the invoice. FIG. 4 illustrates the second page of the invoice.

The invoice is composed of words, phrases and images. The number and combination of the words, phrases and images, as well as the spatial relationships between them, uniquely identifies a vendor and billing platform with the invoice. In this case, the vendor is Public Service Enterprise Group (PSEG) and the billing platform is a monthly gas and electric bill.

In FIG. 3, the invoice is divided into two sections. The left column contains the vendor name (e.g. PSEG) and contact information. The right column contains the customer's account number, the invoice number and a series of summary billing components (e.g. billing components 310-350).

In FIG. 4, the left column contains usage information. The right column contains the billing components that comprise each summary billing component in FIG. 3. For example, billing components 445 and 475 comprise summary billing component 340.

As discussed above, in order to validate an invoice, preprocessor 210 first identifies the vendor and billing platform associated with the invoice. In the example invoice, the “PSEG” image and contact information in the left column, and the “PSEG” text in the right column, identifies the vendor as “PSEG”. The presence of “Gas” and “Electric” in summary billing components 430 and 440, respectively, identifies the billing platform as a monthly gas and electric bill.

In order to ensure that the vendor and billing platform is accurately identified, preprocessor 210 may apply a threshold test to potential vendor and billing platform identifiers. In the example invoice, preprocessor 210 may require that 75% of the potential vendor identifiers match “PSEG” before the vendor is identified as “PSEG”.

Once the vendor and billing platform is identified, preprocessor 210 uses a vendor and billing platform specific template to locate the billing components in the invoice. In FIG. 3, summary billing components 310-350 would be identified. In FIG. 4, the billing components that comprise each summary billing component would be identified, e.g. billing components 405, 410, 420-440 and 450-470.

Preprocessor 210 then outputs a hierarchical data structure that contains the identified billing components. The hierarchical data structure also stores the various relationships between the different billing components.

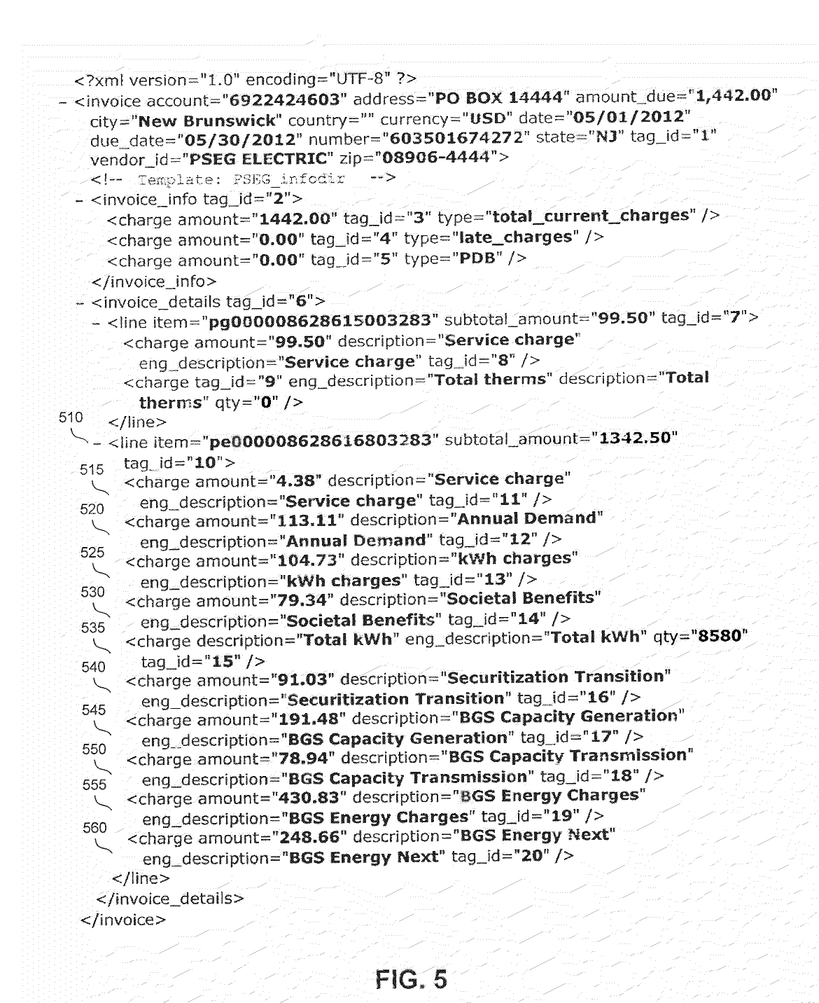

An example hierarchical data structure is illustrated in FIG. 5. FIG. 5 shows the identified billing components from FIGS. 3 and 4 stored in a XML file. In addition to storing the billing components, the XML file captures the relationships between the various billing components. For example, billing component 340 is represented as XML element 510. Similarly, billing components 420, 425, 430, 435, 440, 450, 455, 460, and 465 are represented as XML elements 515, 520, 525, 530, 540, 545, 550, 555 and 560, respectively.

As discussed above, analysis engine 220 analyzes the hierarchical data structure in order to validate the invoice for completeness and accuracy. In the case of FIG. 5, analysis engine 220 would confirm that billing components 310-350 are present in the XML file. Billing components 310-350 represent summary data such as the current gas amount (e.g. 330), the current electric amount (e.g. 340) and the total amount due (e.g. 350). Because the current gas amount and the current electric amount are necessary to compute the total amount due, both must be present in the XML file. Similarly, because the total amount due is necessary for payment of the invoice, it must be present in the XML file.

In addition, analysis engine 220 validates the accuracy of the billing components by applying vendor and billing platform specific rules. For example, billing component 350 (e.g. total amount due) must be equal to the sum of billing components 310 (e.g. previous balance), 320 (e.g. previous payment), 330 (e.g. current gas amount) and 340 (e.g. current electric amount). Similarly, billing component 475 (or 340) must be equal to the sum of billing components 445 (e.g. delivery subtotal) and 470 (e.g. supply subtotal).

Analysis engine 220 may also apply other rules to validate the accuracy of billing components. For example, billing component 450 (e.g. BGS Capacity Generation) is equal to billing component 480 (e.g. generation kW) multiplied by the rate per kW (e.g. $5.41822297).

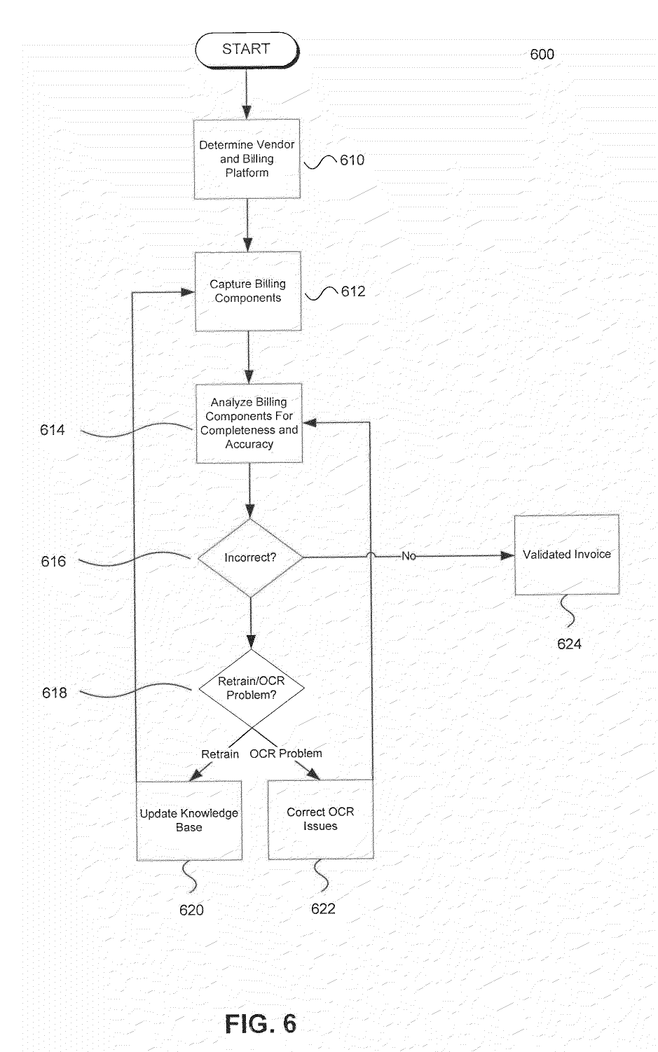

FIG. 6 is a flowchart of an exemplary method 600 for verifying an invoice for completeness and accuracy according to embodiments of the present invention. Other structural embodiments will be apparent to persons skilled in the relevant art(s) based on the following discussion. The operations show FIG. 6 need not occur in the order shown, nor does method 600 require all of the operations shown in FIG. 6 be performed. The operations of FIG. 6 are described in detail below.

In step 610, machine encoded text 110 generated by OCR engine 108 or machine encoded text inputted manually is analyzed to determine the vendor and billing platform associated with the invoice. In particular, the machine encoded text of the invoice is compared with a general knowledgebase that looks for any number or combinations of words and phrases, the spatial relationships of these words, and images. As would be appreciated by a person of ordinary skill in the art, various pattern matching methods may be used to determine the vendor and billing platform associated with the invoice.

In step 612, once the vendor and billing platform is identified, the invoice is analyzed to capture billing components specific to that vendor and billing platform. In particular, OIR engine 112 looks up the vendor and billing platform specific template 240 and rules 250 in knowledge base 230 that are associated with the identified vendor and billing platform. OIR engine 112 then applies template 240 in order to locate and capture all the billing components. Each billing component is assigned a unique tag number. OIR engine 112 then stores the captured billing components in a hierarchical data structure such as an XML file.

In step 614, OIR engine 112 analyzes the hierarchical data structure representing the invoice for completeness and accuracy. In particular, OIR engine 112 applies a collection of rules 250 for a specific vendor and billing platform stored in knowledge base 230 to the identified billing components. The rules 250 define what billing components are required in the invoice and the relationships between the billing components. For example, a rule might specify that the sum of the Federal, State, and local taxes billing components should equal the Total taxes billing component. In another example, a rule might specify that there must always be a Total Charges billing component present in the invoice.

In step 616, if there no inaccurate or missing billing components then operation continues to step 624. Otherwise, the inaccurate or missing billing components are flagged based on each billing components unique tag number and operation continues at step 318.

In step 618, the user is presented with the flagged billing components. The billing components were flagged either because the vendor and billing platform specific template and rules in knowledge base 230 need to be retrained or because of an OCR problem. If the vendor and billing platform template and rules need to be retrained then operation continues to step 620. Otherwise, if the OCR recognition process was problematic then operation continues to step 622.

In step 620, knowledge base 230 has incomplete or inaccurate templates or rules. The user, therefore, adds new or corrected information to the knowledge base. For example, new or corrected rules and templates may be added to template 240 and rules 250 for the corresponding vendor and billing platform in knowledge base 230. Operation then continues to step 612 where the new or corrected information is applied to the invoice in order correctly identify and analyze the billing components.

In step 622, OCR engine 108 produced an incorrect translation of the invoice into machine encoded text. Therefore, the user either corrects the machine encoded text directly or rescans/OCRs the invoice. Because the billing components are flagged, a user can often simply enter the corrected invoice information directly. Operation then continues to step 610 where the corrected machine encoded text is rerun through method 300.

In step 624, OIR engine 112 produces a validation result of success and presents the validated invoice to the user or other modules for further processing.

### Example General Purpose Computer System

Embodiments presented herein, or portions thereof, can be implemented in hardware, firmware, software, and/or combinations thereof.

The embodiments presented herein apply to any communication system between two or more devices or within subcomponents of one device. The representative functions described herein can be implemented in hardware, software, or some combination thereof. For instance, the representative functions can be implemented using computer processors, computer logic, application specific circuits (ASIC), digital signal processors, etc., as will be understood by those skilled in the arts based on the discussion given herein. Accordingly, any processor that performs the functions described herein is within the scope and spirit of the embodiments presented herein.

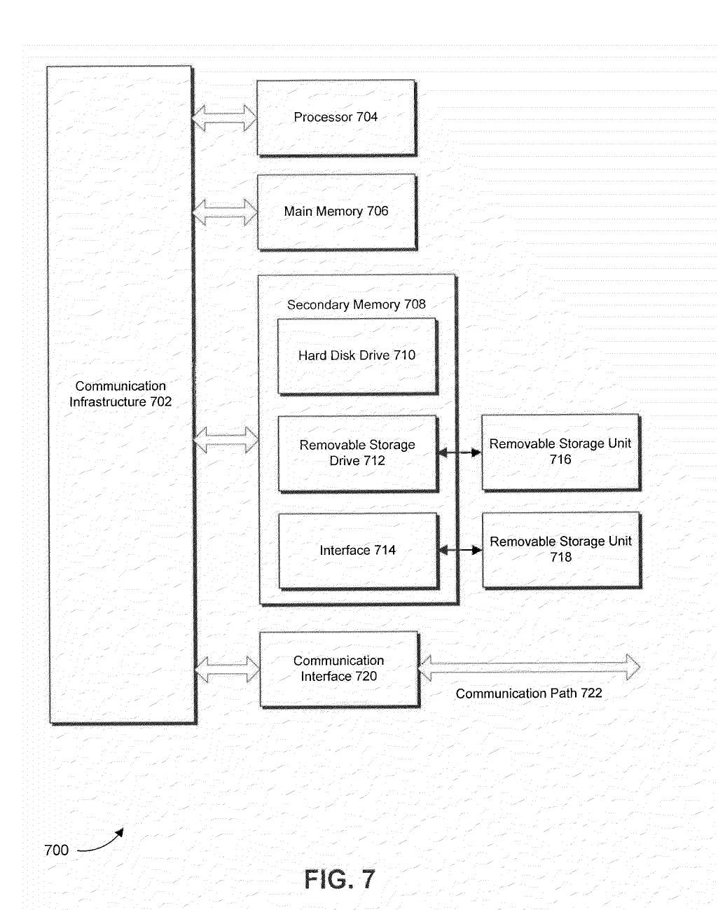

The following describes a general purpose computer system that can be used to implement embodiments of the disclosure presented herein. The present disclosure can be implemented in hardware, or as a combination of software and hardware. Consequently, the disclosure may be implemented in the environment of a computer system or other processing system. An example of such a computer system 700 is shown in FIG. 7. The computer system 700 includes one or more processors, such as processor 704. Processor 704 can be a special purpose or a general purpose digital signal processor. The processor 704 is connected to a communication infrastructure 702 (for example, a bus or network). Various software implementations are described in terms of this exemplary computer system. After reading this description, it will become apparent to a person skilled in the relevant art how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 420 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

While various embodiments have been described above, it should be understood that they have been presented by way of example, and not limitation. It will be apparent to persons skilled in the relevant art that various changes in form and detail can be made therein without departing from the spirit and scope of the embodiments presented herein.

The embodiments presented herein have been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed embodiments. One skilled in the art will recognize that these functional building blocks can be implemented by discrete components, application specific integrated circuits, processors executing appropriate software and the like or any combination thereof. Thus, the breadth and scope of the present embodiments should not be limited by any of the above-described exemplary embodiments, but should be defined only in accordance with the following claims and their equivalents.

What is claimed is:

1. A computer-readable storage device having computer-executable instructions stored thereon, execution of which, by a computing device, causes the computing device to perform operations comprising:
identifying a vendor associated with a machine-encoded text;
identifying a knowledge base associated with the vendor;
extracting one or more billing components from the machine-encoded text according to the knowledge base;
arranging the billing components in a hierarchical data structure; and
validating the billing components arranged in the hierarchical data structure according to the knowledge base.

2. The computer-readable storage device of claim 1 further comprising receiving a scanned image of an invoice and converting the scanned image into the machine-encoded text.

3. The computer-readable storage device of claim 1 wherein the knowledge base comprises a template and a plurality of rules.

4. The computer-readable storage device of claim 3 wherein the template is applied to the machine-encoded text in order to locate the billing components.

5. The computer-readable storage device of claim 3 wherein the plurality of rules is applied to the hierarchical data structure in order to validate the billing components.

6. The computer-readable storage device of claim 1 wherein the hierarchical data structure is a XML file.

7. The computer-readable storage device of claim 1 wherein each of the billing components is either a parent billing component or a child billing component.

8. The computer-readable storage device of claim 1 wherein the billing components are either a charge, usage, or quantity.

9. A method of processing invoices comprising:
identifying a vendor associated with a machine-encoded text;
identifying a knowledge base associated with the vendor;
extracting one or more billing components from the machine-encoded text according to the knowledge base;
arranging the billing components in a hierarchical data structure; and
validating the billing components arranged in the hierarchical data structure according to the knowledge base.

10. The method of claim 9 further comprising receiving a scanned image of an invoice and converting the scanned image into the machine-encoded text.

11. The method of claim 9 wherein the knowledge base comprises a template and a plurality of rules.

12. The method of claim 11 wherein the template is applied to the machine-encoded text in order to locate the billing components.

13. The method of claim 11 wherein the plurality of rules is applied to the hierarchical data structure in order to validate the billing components.

14. The method of claim 9 wherein the hierarchical data structure is a XML file.

15. The method of claim 9 wherein each of the billing components is either a parent billing component or a child billing component.

16. The method of claim 9 wherein the billing components are either a charge, usage, or quantity.

17. An invoice management system comprising:
an optical invoice recognition engine configured to:
receive machine-encoded text;
identify a vendor associated with the machine-encoded text;
identify a knowledge base associated with the vendor;
extract one or more billing components from the machine-encoded text according to the knowledge base; and
arrange the billing components in a hierarchical data structure; and
an analysis engine configured to:
receive the hierarchical data structure; and
validate the billing components arranged in the hierarchical data structure according to the knowledge base.

18. The invoice management system of claim 1 further comprising an optical character recognition engine configured to receive a scanned image of an invoice and convert the scanned image into the machine-encoded text.

19. The invoice management system of claim 1 wherein the knowledge base comprises a template and a plurality of rules.

20. The invoice management system of claim 3 wherein the template is applied to the machine-encoded text in order to locate the billing components.

21. The invoice management system of claim 1 wherein the hierarchical data structure is a XML file.

22. The invoice management system of claim 1 wherein each of the billing components is either a parent billing component or a child billing component.

23. The invoice management system of claim 3 wherein the plurality of rules is applied to the hierarchical data structure in order to validate the billing components.

24. The invoice management system of claim 1 wherein the billing components are either a charge, usage, or quantity.
